(19) United States
(12) Patent Application Publication
(10) Pub. No.: US 2025/0377949 A1
(43) Pub. Date: Dec. 11, 2025

(54) WORKLOAD PROVISIONING SYSTEM

(71) Applicant: Dell Products L.P., Round Rock, TX (US)

(72) Inventors: Douglas Lang Farley, Round Rock, TX (US); Ethan A. Kaley, North Kingstown, RI (US); Joshua Gill, Apex, NC (US)

(21) Appl. No.: 18/735,770

(22) Filed: Jun. 6, 2024

(51) Int. Cl. G06F 9/50; G06F 11/34

(52) U.S. Cl. CPC G06F 9/5044; G06F 9/5083; G06F 11/3433

(57) ABSTRACT

A workload provisioning system includes a resource management system coupled to a client device and resource devices. The resource management system retrieves respective resource capability information and a respective resource/workload configuration template from each resource device. The resource management system then receives a workload intent from the client device with workload intent tag(s) defining respective workload capabilities desired for a workload, and uses it with the respective resource capability information to identify a subset of the resource devices to provide the respective workload capabilities. The resource management system then fills the respective resource/workload configuration template for each of the first subset of the resource devices based on their respective resource capability information to provide respective first resource/workload configuration information that it then combines to provide a first resource/workload configuration file that it uses to configure the first subset of resource devices to provide an LCS that performs the workload.

### BACKGROUND

The present disclosure relates generally to information handling systems, and more particularly to performing workloads using information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices (e.g., “Bare Metal Servers (BMSs)) and/or other computing devices known in the art, are often utilized to perform workloads. For example, a user or administrator may provide a request to perform a workload, a server device may be selected for performing that workload, and the resources of that server device may then be subsequently used to perform that workload. However, the conventional provisioning of workloads using resource devices in server devices require a user to identify each workload capability that is required by that workload (e.g., particular storage capabilities), identify the resource device(s) that are configured to provide each of those capabilities (e.g., Redundant Array of Independent Disk (RAID) storage capabilities), identify the hardware and software dependencies for each of those resource device(s), and configure applications (e.g., a storage application) that enables those workload capabilities (e.g., an application that addresses metadata database dependencies, storage networking connection dependencies, and/or other hardware and software dependencies). As such, the conventional provisioning of workloads requires a relatively high level of knowledge and training to perform the time-consuming compilations and integrations of the information needed to enable the performance of those workloads.

Accordingly, it would be desirable to provide a workload provisioning system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a resource management engine that is configured to: retrieve, from each of a plurality of resource devices that are coupled to the processing system, respective resource capability information and a respective resource/workload configuration template; receive, from a client device that is coupled to the processing system, a workload intent that requests performance of a workload and that includes at least one workload intent tag that defines a respective workload capability desired for the workload; identify, using the at least one workload intent tag and the respective resource capability information retrieved from each of the plurality of resource devices, a first subset of the plurality of resource devices that are configured to provide each of the respective workload capabilities defined by the at least one workload intent tag; fill, based on the respective resource capability information retrieved from each of the first subset of the plurality of resource devices, the respective resource/workload configuration template retrieved from each of the first subset of the plurality of resource devices to provide respective first resource/workload configuration information; combine the respective first resource/workload configuration information to provide a first resource/workload configuration file; and configure, using the first resource/workload configuration file, the first subset of the plurality of resource devices to provide a Logically Composed System (LCS) that performs the workload.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a schematic view illustrating an embodiment of the workload provisioning system provided according to the teachings of the present disclosure.

FIG. 8 is a flow chart illustrating an embodiment of a method for providing a workload.

FIG. 9 is a schematic view illustrating an embodiment of the workload provisioning system of FIG. 7 operating during the method of FIG. 8.

FIG. 10 is a schematic view illustrating an embodiment of the workload provisioning system of FIG. 7 operating during the method of FIG. 8.

FIG. 11 is a schematic view illustrating an embodiment of the workload provisioning system of FIG. 7 operating during the method of FIG. 8.

FIG. 12 is a schematic view illustrating an embodiment of the workload provisioning system of FIG. 7 operating during the method of FIG. 8.

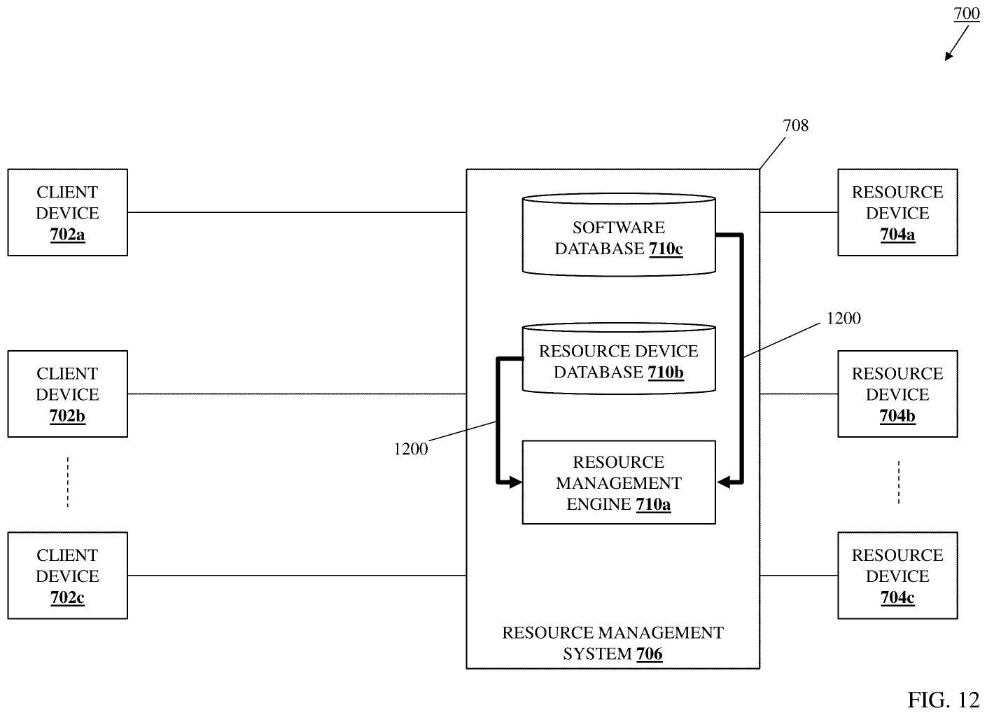

FIG. 13 is a schematic view illustrating an embodiment of the workload provisioning system of FIG. 7 operating during the method of FIG. 8.

FIG. 14 is a schematic view illustrating an embodiment of the workload provisioning system of FIG. 7 operating during the method of FIG. 8.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

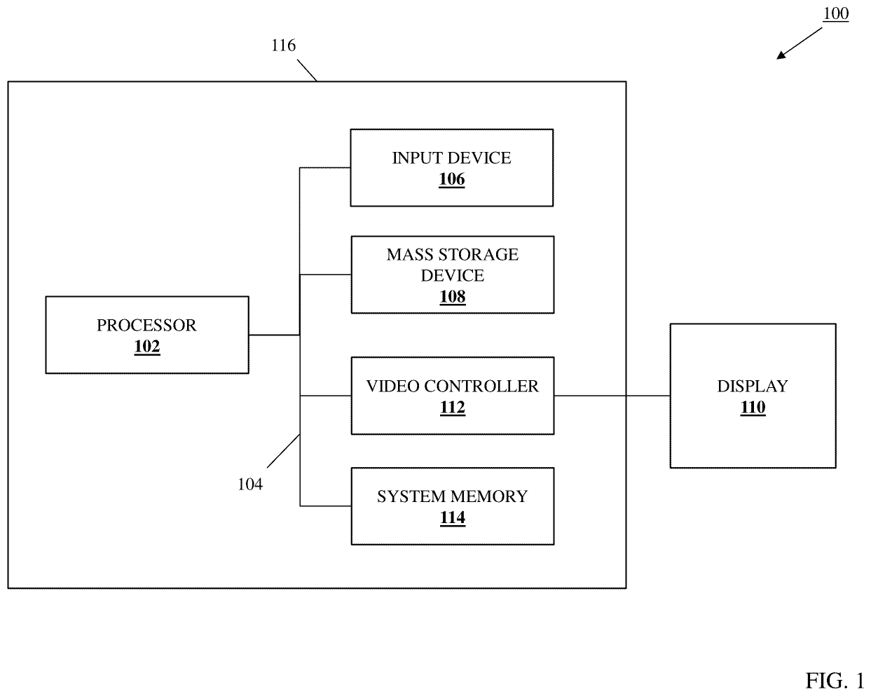

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the workload provisioning systems and methods of the present disclosure may be utilized with Logically Composed Systems (LCSs), which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

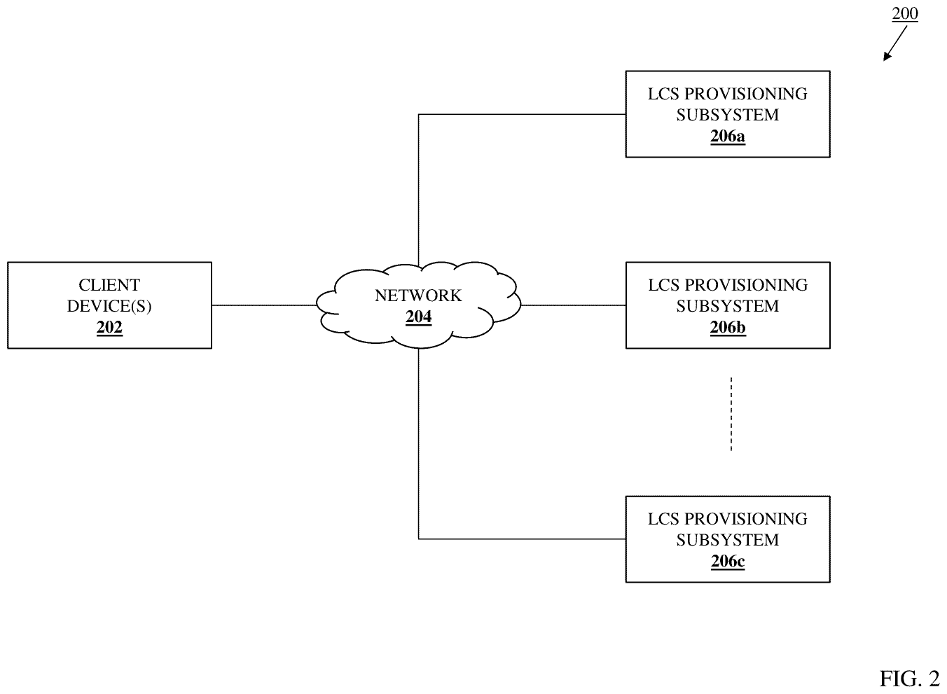

With reference to FIG. 2, an embodiment of a Logically Composed System (LCS) provisioning system 200 is illustrated that may be utilized with the workload provisioning systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

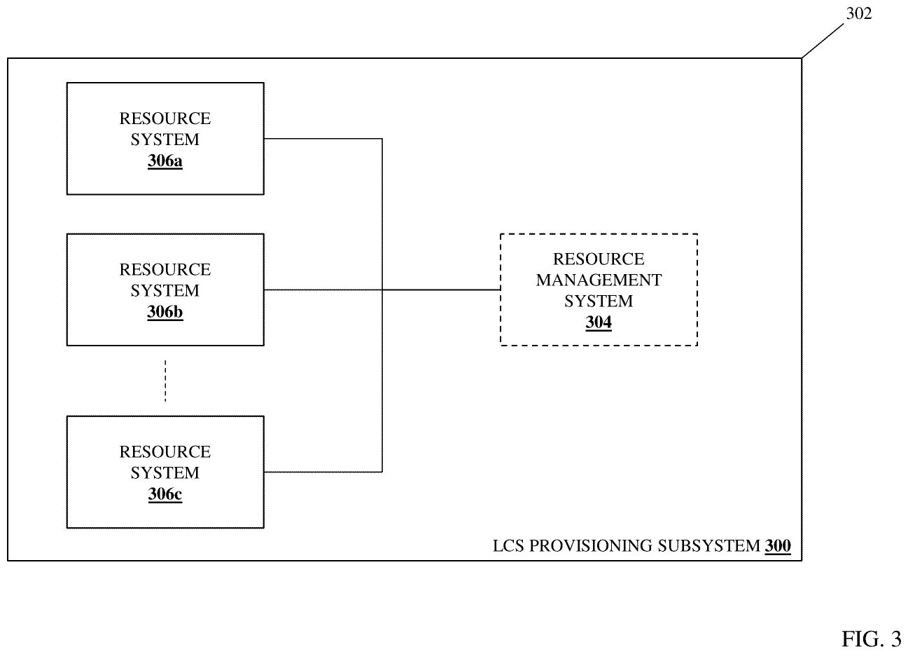

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

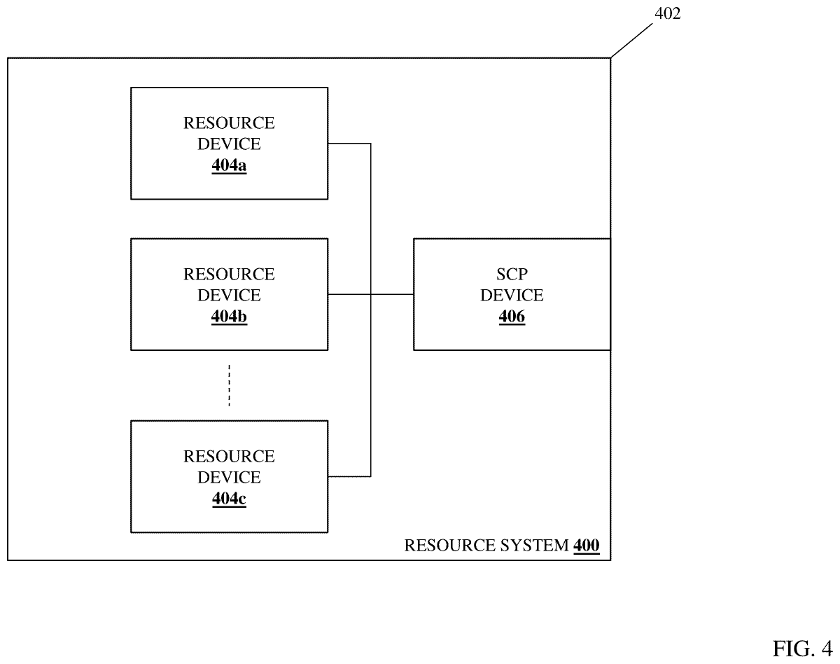

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciate that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

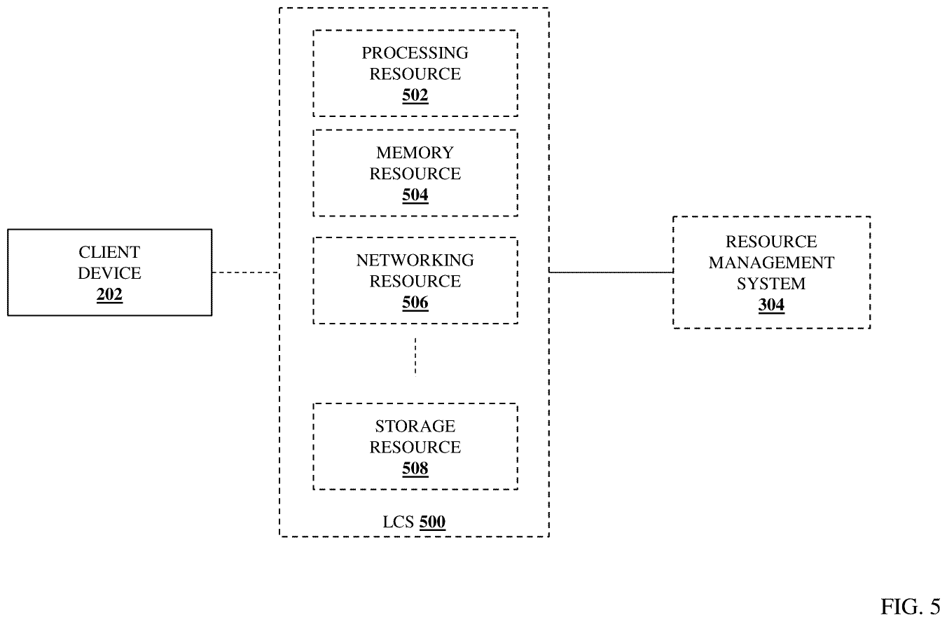

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

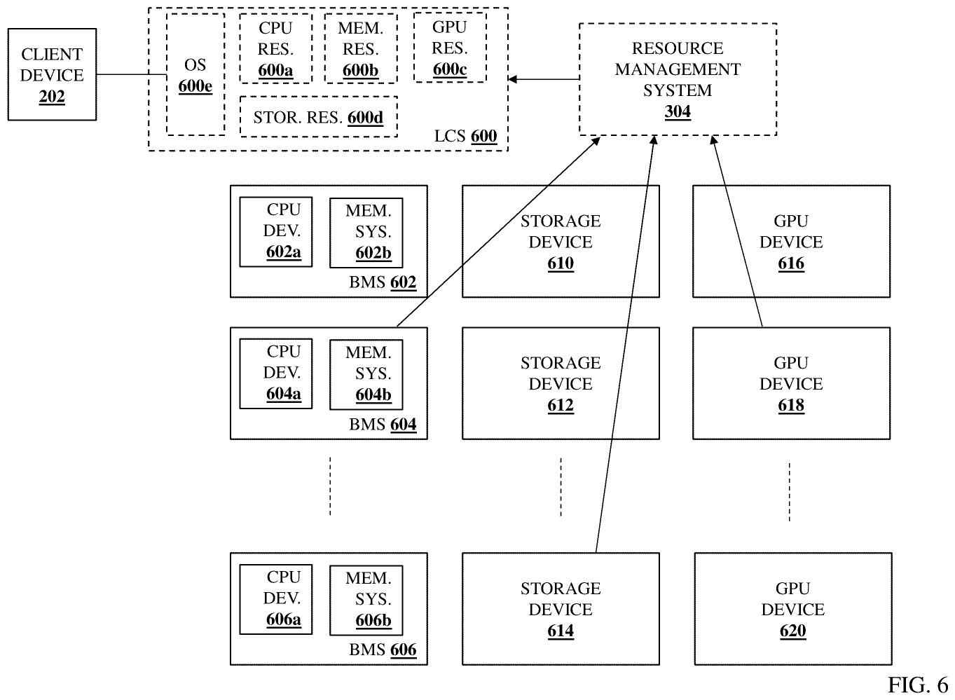

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

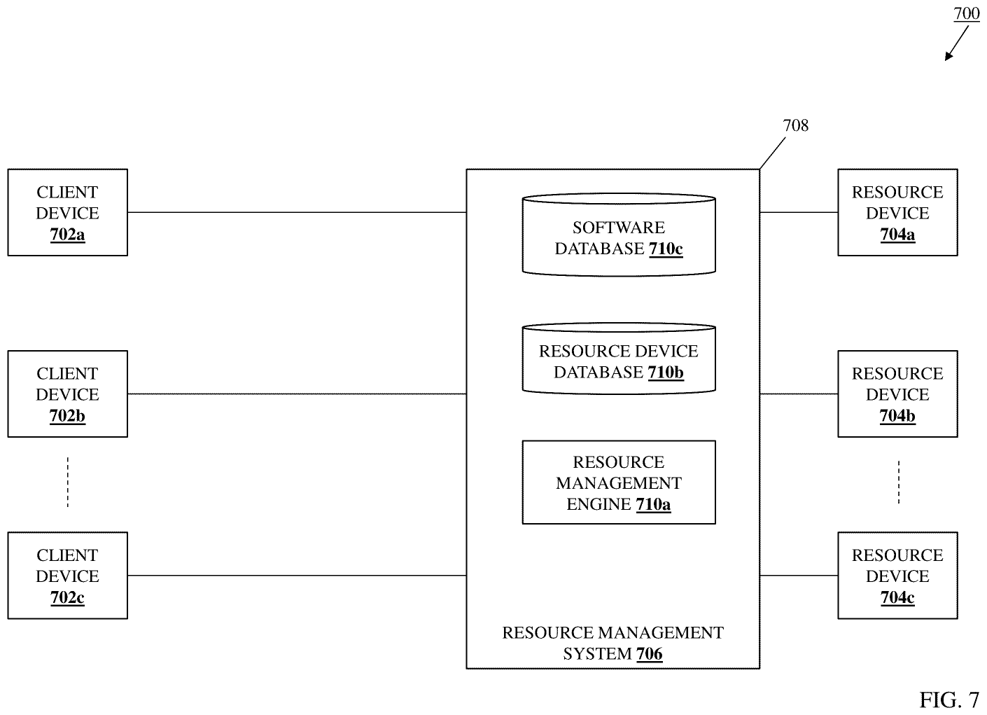

Referring now to FIG. 7, an embodiment of a workload provisioning system 700 is illustrated that may be provided using the LCS provisioning system 200 described above with reference to FIG. 2, the LCS provisioning subsystem described above with reference to FIG. 3, and the resource system 400 described above with reference to FIG. 4, and may operate similarly as described with reference to FIGS. 5 and 6. In the illustrated embodiment, the workload provisioning system 700 includes a plurality of client devices 702a, 702b, and up to 702c that may be provided by any of the client device(s) 202 of FIG. 2. Furthermore, the workload provisioning system 700 also includes a plurality of resource devices 704a, 704b, and up to 704c that may be provided by any of the resource devices 404a-404c of FIG. 4; the CPU device/memory system combinations 602a/602b, 604a/604b, and 606a/606b in the BMSs 602, 604, and 606, respectively, of FIG. 6; the storage devices 610, 612, and 614 of FIG. 6; the GPU devices 616, 618, and 620 of FIG. 6; and/or any other resource devices described above. Finally, in the illustrated embodiment, the workload provisioning system 700 includes a resource management system 706 that is coupled to the client devices 702a-702c and the resource devices 704a-704c, and that may be provided by the resource management system 304 of FIGS. 3, 5, and/or 6.

In the illustrated embodiment, the resource management system 706 includes a chassis 708 that houses and/or otherwise supports the components of the resource management system 706, only some of which are illustrated and described below. For example, the chassis 708 may house and/or support a resource management processing system (not illustrated, but which may be similar to the processor 102 discussed above with reference to FIG. 1) and a resource management memory system (not illustrated, but which may be similar to the memory 114 discussed above with reference to FIG. 1) that is coupled to the resource management processing system and that includes instructions that, when executed by the resource management processing system, cause the resource management processing system to provide a resource management engine 710a that is configured to perform the functionality of the resource management engines, resource management subsystems, and/or resource management systems discussed below.

The chassis 302 may also house a resource management storage system (not illustrated, but which may be similar to the storage 108 discussed above with reference to FIG. 1) that is coupled to the resource management engine 710 (e.g., via a coupling between the resource management storage system and the resource management processing system) and that includes a resource device database 710b that is configured to store information identifying the resource devices 704a-704c coupled to the resource management system 706, as well as any of other resource device information utilized by the resource management engine 710a as discussed below. The resource management storage system also includes a software database 710c that is configured to store software as well as any of other software information utilized by the resource management engine 710a as discussed below. However, while a specific resource management system 706 has been illustrated and described, one of skill in the art in possession of the present disclosure will recognize that resource management systems (or other devices operating according to the teachings of the present disclosure in a manner similar to that described below for the resource management system 706) may include a variety of components and/or component configurations for providing conventional resource management functionality, as well as the workload provisioning functionality discussed below, while remaining within the scope of the present disclosure as well.

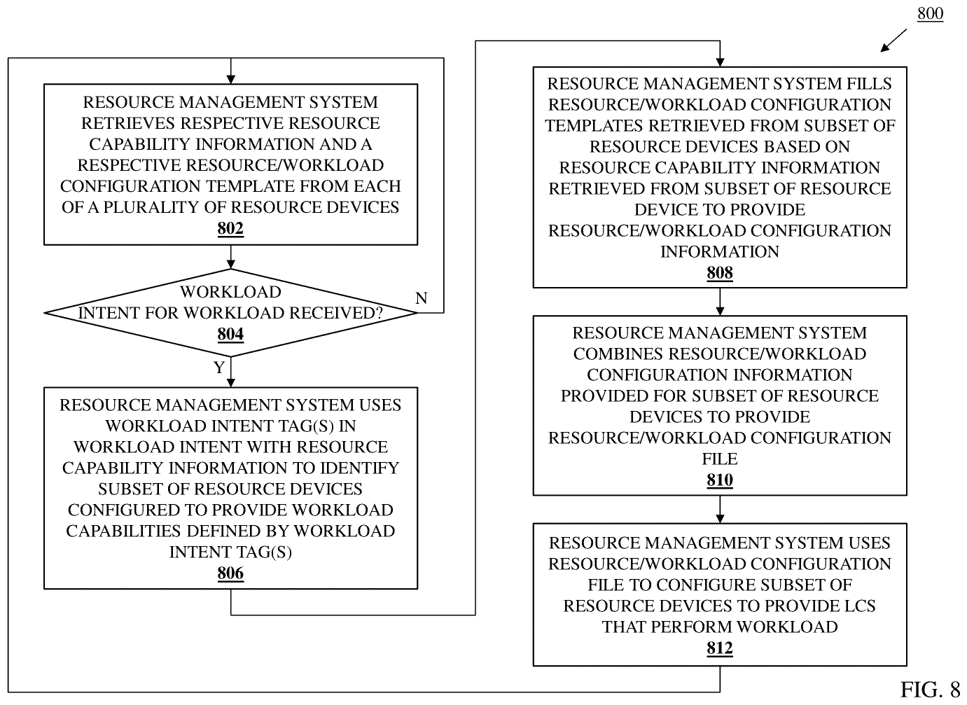

Referring now to FIG. 8, an embodiment of a method 800 for providing a workload is illustrated. As discussed below, the systems and methods of the present disclosure allow a user to provide a workload intent using “human-friendly” workload intent tag(s) (e.g., FQDN formatted tags), with those workload intent tags configured for use in identifying resource devices for providing an LCS that performs a workload having desired workload capabilities, as well as for use in filling in resource/workload configuration templates (e.g., the TOSCA-based resource/workload configuration templates described below,) retrieved from those resource devices to generate a resource/workload configuration file that is used to configure those resource devices to provide the LCS that performs the workload.

For example, the workload provisioning system of the present disclosure may include a resource management system coupled to a client device and resource devices. The resource management system retrieves respective resource capability information and a respective resource/workload configuration template from each resource device. The resource management system then receives a workload intent from the client device with workload intent tag(s) defining respective workload capabilities desired for a workload, and uses it with the respective resource capability information to identify a subset of the resource devices to provide the respective workload capabilities. The resource management system then fills the respective resource/workload configuration template for each of the first subset of the resource devices based on their respective resource capability information to provide respective first resource/workload configuration information that it then combines to provide a first resource/workload configuration file that it uses to configure the first subset of resource devices to provide an LCS that performs the workload. As such, workloads may be provided without the need for users to perform time-consuming compilations and integrations of the information needed to enable the performance of those workloads, which is required by conventional workload provisioning systems and necessitates a relatively high level of knowledge and training.

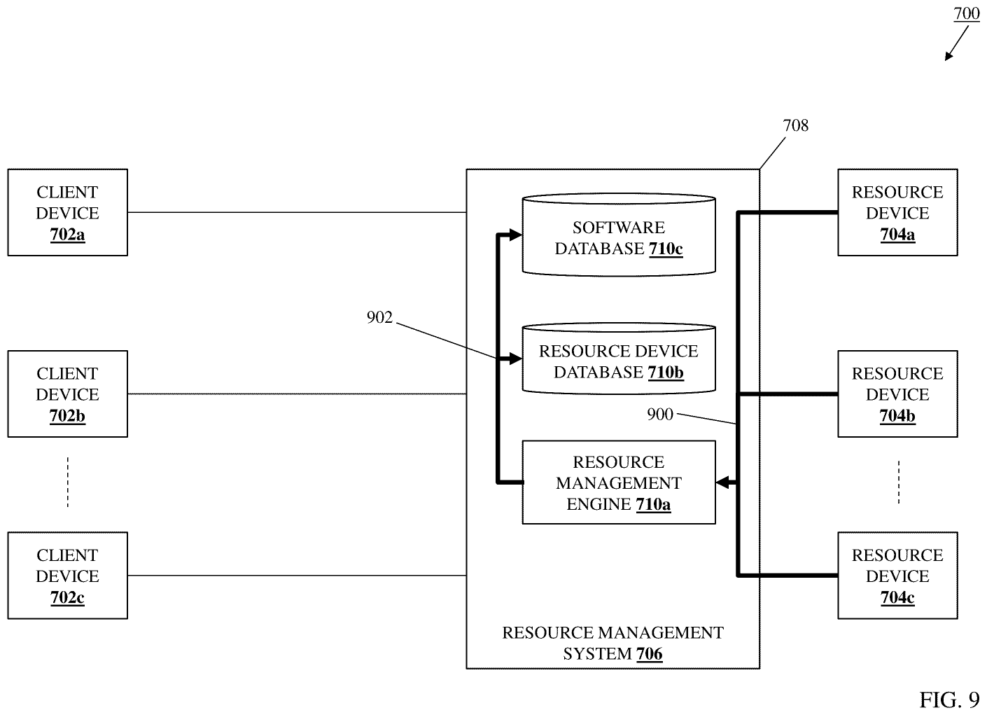

The method 800 begins at block 802 where a resource management system retrieves respective resource capability information and a respective resource/workload configuration template from each of a plurality of resource devices. With reference to FIG. 9, in an embodiment of block 802, the resource management engine 710a in the resource management system 706 may perform resource device information retrieval operations 900 that may include retrieving information from each of the resource devices 704a-704c to which it has access. For example, the resource device information retrieval operations 900 performed by the resource management engine 710a with any particular resource device may include the retrieval of resource capability information for that resource device that may be included in one or more resource capabilities “tags” that may be provided by metadata stored in the resource device, and may identify properties, functionality, dependencies, current statuses, and/or other capabilities of the resource device that one of skill in the art in possession of the present disclosure would recognize define how that resource device may be “consumed” to perform a workload.

In a specific example, a resource device provided by hardware may include a memory device (e.g., an Electrically Programmable Read-Only Memory (EEPROM) device) or other storage subsystem that stores the metadata that provides the resource capabilities tag(s) described above, and that resource device may include an agent that is configured to communicate with the resource management engine 710a in order to provide those resource capabilities tag(s) to the resource management engine 710a. As such, any of the resource devices 704a-704c provided by hardware may advertise their resource capabilities, may have those resource capabilities “pulled” by the resource management engine 710a, may “push” those resource capabilities to the resource management engine 710a, and/or otherwise provide its resource capabilities to the resource management engine 710a at block 802.

In another specific example, a resource device may provide software (or may be associated with software that is configured for use with that resource device and that may be stored in a software repository, the software database 710c, and/or other software storage locations that would be apparent to one of skill in the art in possession of the present disclosure) that includes the metadata that provides the resource capabilities tag(s) described above, and an agent may be provided to communicate with the resource management engine 710a in order to provide those resource capabilities tag(s) to the resource management engine 710a. As such, any resource device, software repository, and/or other software storage location may advertise the resource capabilities of its software, may have those resource capabilities “pulled” by the resource management engine 710a, may “push” those resource capabilities to the resource management engine 710a, and/or otherwise provide the resource capabilities of its software to the resource management engine 710a at block 802.

Thus, the resource devices and software accessible to the resource management engine 710a (e.g., compute images, software components, firmware, “blobs”, hardware, etc.) may each include the resource capabilities tags described above that identify how they may be consumed to perform workloads, and those resource capabilities tags may be retrieved by the resource management engine 710a using any of a variety of information retrieval techniques that would be apparent to one of skill in the art in possession of the present disclosure. As illustrated in FIG. 9, the resource management engine 710a in the resource management system 706 may perform resource capability storage operations 902 that include storing resource capabilities received for the resource devices 704a-704c in the resource device database 710b, and storing resource capabilities received for software in the software database 710c.

Furthermore, the resource device information retrieval operations 900 performed by the resource management engine 710a with any particular resource device may also include the retrieval of respective resource/workload configuration templates from each of the plurality of resource device 704a-704c. For example, each resource/workload configuration template retrieved at block 802 may be a Topology and Orchestration Specification for Cloud Applications (TOSCA)-based resource/workload template for that resource device that, as described below, is fillable to generate resource/workload configuration information (e.g., TOSCA-based resource/workload configuration information) for that resource device that may be provided in a resource/workload configuration information file (e.g., a TOSCA-based resource/workload configuration file) that one of skill in the art in possession of the present disclosure will recognize may be used to configure resource device to provide an LCS that performs a workload.

For example, the workloads of the present disclosure may be performed by LCSs that are provided by resource devices that are configured using a TOSCA subsystem that utilizes a TOSCA modeling language, and the TOSCA-based resource/workload templates described above may be provided for each resource device such that they are fillable with the details required to define how any of the capabilities of that resource device used to perform a workload in order to generate TOSCA-based resource/workload configuration information, with the TOSCA-based resource/workload configuration information generated for any subset of resource devices combinable to generate a TOSCA-based resource/workload configuration file that may be used to configure those resource devices to provide a workload with desired workload capabilities.

To provide a specific example, a portion of TOSCA-based resource/workload template is provided below that one of skill in the art in possession of the present disclosure will appreciate provides a template for network access details for a resource device:

node_types:
...
topology_temlpate:
...
network_subnet:
type: string
default: _{——}
instance_type:
type: string
default: _{——}
...

The method 800 then proceeds to decision block 804 where the method 800 proceeds depending on whether a workload intent identifying workload capabilities of a workload is received. Similarly as discussed above with reference to FIG. 5, any user or administrator may use any of the client devices 702a-702c to express a workload intent that describes the general requirements of a workload that user would like to have performed. As such, at decision block 804, the resource management engine 710a in the resource management system 706 may monitor for workload intents provided by the client devices 702a-702c.

If, at decision block 804, no workload intent is received, the method 800 returns to decision block 802. As such, the method 800 may loop such that the resource management engine 710a continues to retrieve resource capability information and resource/workload configuration templates from resource devices (i.e., when such resource capability information and resource/workload configuration templates have not already been retrieved) and monitor for a workload intent provided by the client devices 702a-702c until a workload intent is received. Thus, the resource management system 706 may maintain a dynamic inventory of resources devices and software that identifies those resource devices and software and their properties, functionality, dependencies, current statuses, and/or other capabilities, and one of skill in the art in possession of the present disclosure will appreciate how that inventory may be modified over time as resource devices and software becomes available (and go unavailable).

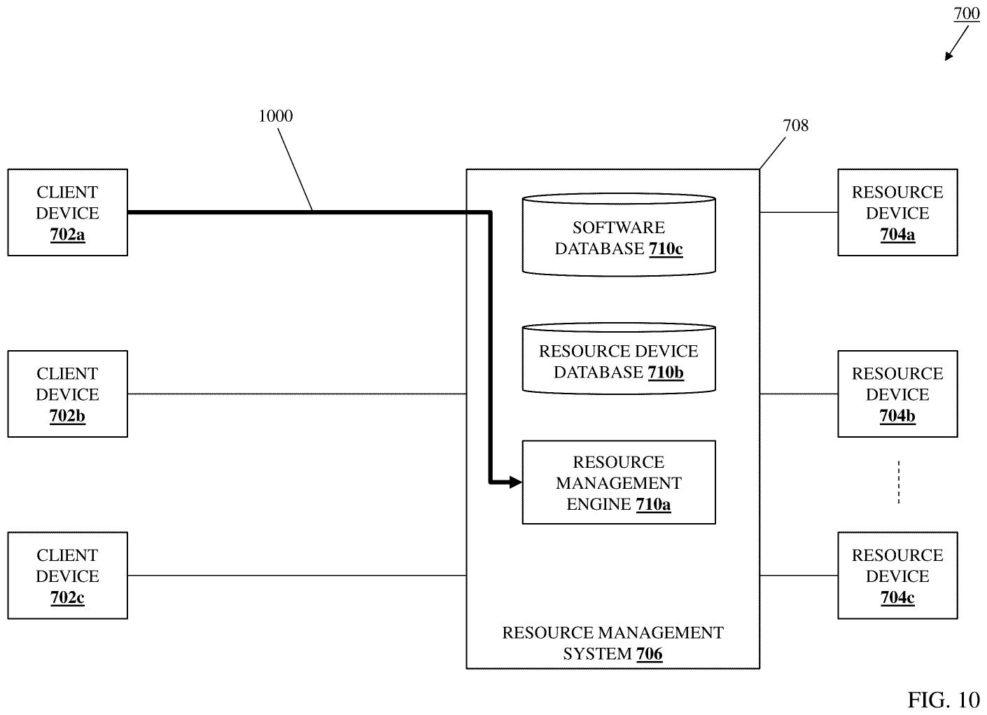

If, at decision block 804, the workload intent is received, the method 800 proceeds to block 806 where a resource management system uses one or more workload intent tags in the workload intent with the resource capability information to identify a subset of resource devices that are configured to provide workload capabilities defined by the one or more workload intent tags. With reference to FIG. 10, in an embodiment of decision block 804, the client device 702a may perform workload intent provisioning operations 1000 that may include generating and transmitting a workload intent that is received by the resource management engine 710a in the resource management system 706.

In an embodiment, the workload provisioning system of the present disclosure may utilize a workload capabilities dictionary, workload capabilities lookup table, and/or other workload capabilities information that may have been previously provided by the workload provisioning system provider, and that provides a workload capabilities “menu” that allows a user to select workload intent tags that identify the workload capabilities for a workload they would like to have performed. As such, some users may utilize that workload capabilities information (e.g., the workload capabilities dictionary discussed above) to generate the workload intent including the workload intent tags for the desired workload (e.g., those users may write code that identifies those workload capabilities using the workload intent tags in the workload capabilities dictionary) at decision block 804. However, in other examples, a workload capabilities User Interface (UI) may be presented to a user that includes the workload intent tags in a plurality of “drop-down” fields, enabling the user to select the workload intent tags from the “drop-down” fields in that workload capabilities UI to identify the workload capabilities desired for their workload, with the workload capabilities UI then automatically generating the workload intent that includes those workload intent tags. However, while some specific examples of the generation of a workload intent have been described, one of skill in the art in possession of the present disclosure will appreciate how the workload intents of the present disclosure may be generated in a variety of manners to request workloads via a workload intent that is annotated with each of the workload capabilities that are desired for a corresponding workload.

In many embodiments, the workload provisioning system of the present disclosure allows users to generate workload intents via the use of “human friendly” workload intent tags that define workload capabilities desired for a workload. For example, any workload intent tags provided according to the teachings of the present disclosure may be provided in a Fully Qualified Domain Name (FQDN) format, with one or more workload tags used to provide the workload intent described above. In a specific example of the present disclosure that implements a Topology and Orchestration Specification for Cloud Applications (TOSCA) subsystem that utilizes a TOSCA modeling language, the workload intent may be considered a “sparse” TOSCA manifest that defines the workload capabilities desired for a workload via the workload intent tag(s). To provide a specific example, a workload capability desired for a workload may include a highly-available block storage system, and may be expressed using the following workload intent tag:
highly-available.block.storage.capabilities.system
   As will be appreciated by one of skill in the art in possession of the present disclosure, the workload intent tag above is provided in the FQDN format with “workload intent labels” replacing the “domain labels” in conventional FQDNs, with a “system” workload intent label identifying that the workload intent tag is for the LCS that will be provided as described below, the “capabilities” workload intent label nested under the “system” workload intent label and identifying that the workload intent tag is for a capability of the LCS, the “storage” workload intent label nested under the “capabilities” workload intent label and identifying that the workload intent tag is for a storage capability of the LCS, the “block” workload intent label nested under the “storage” workload intent label and identifying that the workload intent tag is requesting a block storage capability for the LCS, and the “highly-available” workload intent label nested under the “block” workload intent label and identifying that the workload intent tag is requesting a highly available block storage capability for the LCS.

To provide another specific example, a workload capability desired for a workload may include an AMAZON® Simple Storage Service (S3) object storage system, and may be expressed using the following workload intent tag:
s3.object.storage.capabilities.system
   Similarly as discussed above, the workload intent tag above is provided in the FQDN format with “workload intent labels” replacing the “domain labels” in conventional FQDNs, with a “system” workload intent label identifying that the workload intent tag is for the LCS that will be provided as described below, the “capabilities” workload intent label nested under the “system” workload intent label and identifying that the workload intent tag is for a capability of the LCS, the “storage” workload intent label nested under the “capabilities” workload intent label and identifying that the workload intent tag is for a storage capability of the LCS, the “object” workload intent label nested under the “storage” workload intent label and identifying that the workload intent tag is requesting an object storage capability for the LCS, and the “s3” workload intent label nested under the “object” workload intent label and identifying that the workload intent tag is requesting an s3 storage capability for the LCS.

To provide another specific example, a workload capability desired for a workload may include a Remote Direct Memory Access (RDMA) over Converged Ethernet (ROCE) Transmission Control Protocol (TCP) networking system, and may be expressed using the following workload intent tag:
ROCE.TCP.networking.capabilities.system
   Similarly as discussed above, the workload intent tag above is provided in the FQDN format with “workload intent labels” replacing the “domain labels” in conventional FQDNs, with a “system” workload intent label identifying that the workload intent tag is for the LCS that will be provided as described below, the “capabilities” workload intent label nested under the “system” workload intent label and identifying that the workload intent tag is for a capability of the LCS, the “networking” workload intent label nested under the “capabilities” workload intent label and identifying that the workload intent tag is for a networking capability of the LCS, the “TCP” workload intent label nested under the “networking” workload intent label and identifying that the workload intent tag is requesting a TCP networking capability for the LCS, and the “ROCE” workload intent label nested under the “TCP” workload intent label and identifying that the workload intent tag is requesting an ROCE TCP networking capability for the LCS.

To provide another specific example, a workload capability desired for a workload may include an InfiniBand (IB) TCP networking system, and may be expressed using the following workload intent tag:
IB.TCP.networking.capabilities.system

Similarly as discussed above, the workload intent tag above is provided in the FQDN format with “workload intent labels” replacing the “domain labels” in conventional FQDNs, with a “system” workload intent label identifying that the workload intent tag is for the LCS that will be provided as described below, the “capabilities” workload intent label nested under the “system” workload intent label and identifying that the workload intent tag is for a capability of the LCS, the “networking” workload intent label nested under the “capabilities” workload intent label and identifying that the workload intent tag is for a networking capability of the LCS, the “TCP” workload intent label nested under the “networking” workload intent label and identifying that the workload intent tag is requesting a TCP networking capability for the LCS, and the “IB” workload intent label nested under the “TCP” workload intent label and identifying that the workload intent tag is requesting an IB TCP networking capability for the LCS.

As such, any workload intent tag provided in a workload intent at block 802 may include a hierarchy/order of workload intent labels that may identify workload capabilities desired for a workload, and may be provided with different levels of workload intent label granularity (continuing with the examples provided above, the workload intent tag “storage.capabilities.system” may be satisfied by any available storage system, and the workload intent tag “networking.capabilities.system” may be satisfied by any available networking system).

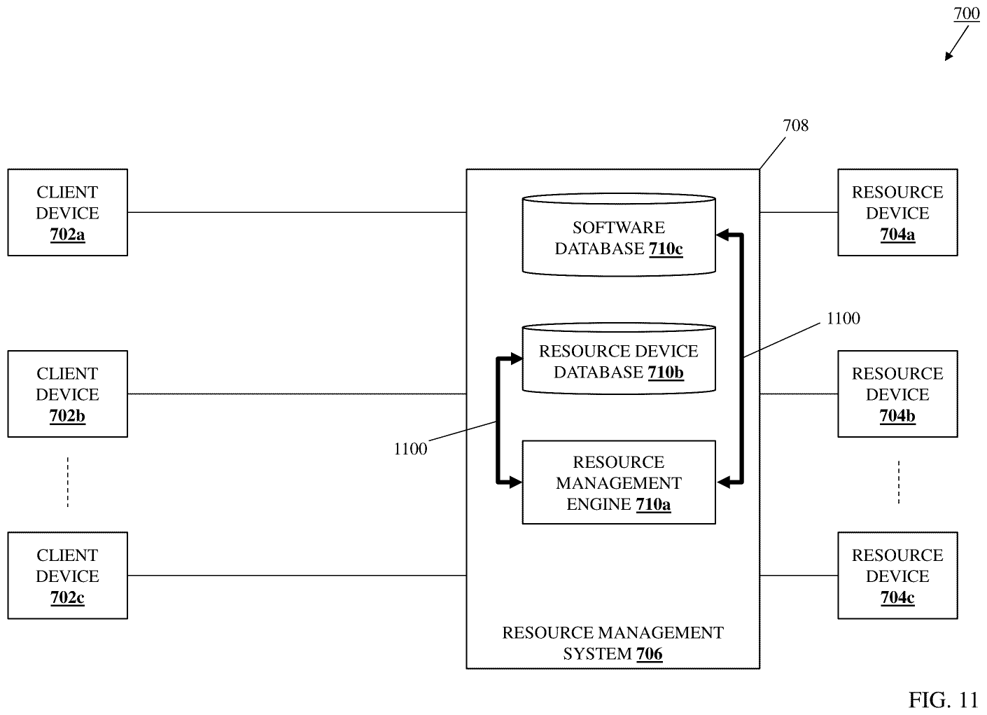

With reference to FIG. 11, in an embodiment of block 806 and in response to receiving the workload intent at decision block 804, the resource management engine 710a in the resource management system 706 may perform resource device identification operations 1000 that include accessing the resource device database 710b and using the resource capability information stored at block 802 to identify resource device(s) whose resource capability information indicate that resource device is configured provide the workload capability/capabilities defined by the workload intent tag(s) in the workload intent. Continuing with the example provided above in which the workload intent includes the “highly-available.block.storage.capabilities.system” workload intent tag, the resource device identification operations 1000 performed by the resource management engine 710a at block 806 may include identifying resource device(s) based on their resource capability information in the resource device database 710b indicating that those resource device(s) provide highly available block storage functionality.

Continuing with the example provided above in which the workload intent includes the “s3.object.storage.capabilities.system” workload intent tag, the resource device identification operations 1000 performed by the resource management engine 710a at block 806 may include identifying resource device(s) based on their resource capability information in the resource device database 710b indicating that those resource device(s) provide s3 object storage functionality. Continuing with the example provided above in which the workload intent includes the “ROCE.TCP.networking.capabilities.system” workload intent tag, the resource device identification operations 1000 performed by the resource management engine 710a at block 806 may include identifying resource device(s) based on their resource capability information in the resource device database 710b indicating that those resource device(s) provide ROCE TCP networking functionality. Continuing with the example provided above in which the workload intent includes the “IB.TCP.networking.capabilities.system” workload intent tag, the resource device identification operations 1000 performed by the resource management engine 710a at block 806 may include identifying resource device(s) based on their resource capability information in the resource device database 710b indicating that those resource device(s) provide IB TCP networking functionality.

Furthermore, while particular resource devices that are configured to provide particular workload capabilities are described as being identified at block 806, one of skill in the art in possession of the present disclosure will appreciate how a variety of other resource devices may be identified for performing a workload while remaining within the scope of the present disclosure. For example, a workload intent including a workload capability of 100 GB of storage capacity may result in the identification of a primary storage system with 100 GB of storage capacity for use in the storage of user data, as well as a secondary storage system providing storage capacity for use in storing non-user data that is require to operate other components for the workload (which may be identified by one or more dependencies included in a workload capability or resource capability).

As such, at block 806 the resource management engine 710a may identify a subset of the resource devices 704a-704c that are configured to provide the workload capabilities desired for the workload and defined by the workload intent tag(s) in the workload intent. As illustrated in FIG. 11, the resource device identification operations 1000 performed by the resource management engine 710a at block 806 may also include accessing the software database 710c and identifying software that is required to provide the workload capabilities desired for the workload and defined by the workload intent tag(s) in the workload intent. For example, based on properties, functionality, dependencies, current statuses, and/or other capabilities identified in the resource capabilities information for the subset of resource devices 704a-704c identified as described above, the resource management engine 710a may identify corresponding software required to enable the workload capabilities defined by the workload intent tag(s) that were provided in the workload intent. To provide a specific example, software required to enable the highly available block storage discussed above may include a storage operating system or application such as, for example, the operating system provided on POWERFLEX® storage systems available from DELL® Inc. of Round Rock, Texas, United States (i.e., the storage operating system will enable the capability of highly available block storage, allowing the resource management system to provide LCSs that use that highly available block storage).

As such, following block 806, the resource management engine 710a may have identified one or more resource devices and corresponding software that is required to provide each workload capability identified by the workload intent tag(s) included in the workload intent, and while simplified examples are provided above, one of skill in the art in possession of the present disclosure will appreciate how such operations may include identifying a large number and wide variety of hardware, firmware, compute images, “blobs”, “containers”, and/or other resources based on their properties, functionality, dependencies, current statuses, and/or other capabilities. As such, the resource management engine 710a may operate as a “capability solver” that is configured to identify an integrated combination of resource devices and software that it may configure as described below to provide each of the workload capabilities identified by the workload intent tags in the workload intent in order to provide an LCS that performs a desired workload.

The method 800 then proceeds to block 808 where the resource management system fills the resource/workload configuration templates retrieved from the subset of resource devices based on the resource capability information of the subset of resource devices to provide resource/workload configuration information. In an embodiment, at block 808, the resource management engine 710a in the resource management device 706 may perform resource/workload configuration template filling operations 1200 that include retrieving the respective resource/workload configuration templates for the subset of the resource devices 704a-704c identified at block 806, and filling the resource/workload configuration templates based on the resource capability information for that subset of resource devices (which may be based on the software required by that resource capability information as well).

Continuing with the examples provided above, the resource/workload configuration templates filled at block 808 may be the TOSCA-based resource/workload templates described above and may be filled with the details required to define the provisioning of any of the capabilities of the subset of resource device identified at block 806 operating via the software identified at block 806 in order to generate TOSCA-based resource/workload configuration information. Continuing with the example provided above in which the workload intent includes the “highly-available.block.storage.capabilities.system” workload intent tag, the resource/workload configuration template filling operations 1200 performed by the resource management engine 710a at block 808 may include filling the TOSCA-based resource/workload template for the resource device(s) identified at block 806 to provide highly available block storage (e.g., at a storage capacity defined in a workload capability included in the workload intent).

Continuing with the example provided above in which the workload intent includes the “s3.object.storage.capabilities.system” workload intent tag, the resource/workload configuration template filling operations 1200 performed by the resource management engine 710a at block 808 may include filling the TOSCA-based resource/workload template for the resource device(s) identified at block 806 to provide S3 object storage (e.g., at a storage capacity defined in a workload capability included in the workload intent). Continuing with the example provided above in which the workload intent includes the “ROCE.TCP.networking.capabilities.system” workload intent tag, the resource/workload configuration template filling operations 1200 performed by the resource management engine 710a at block 808 may include filling the TOSCA-based resource/workload template for the resource device(s) identified at block 806 to provide ROCE TCP networking (e.g., at a networking capacity defined in a workload capability included in the workload intent).

Continuing with the example provided above in which the workload intent includes the “IB.TCP.networking.capabilities.system” workload intent tag, the resource/workload configuration template filling operations 1200 performed by the resource management engine 710a at block 808 may include filling the TOSCA-based resource/workload template for the resource device(s) identified at block 806 to provide IB TCP networking (e.g., at a networking capacity defined in a workload capability included in the workload intent). As such, following block 808, the resource/workload configuration template for each of the subset of resource devices identified at block 806 may be filled.

To provide a specific example, the portion of TOSCA-based resource/workload template discussed above may be filled the following information, which one of skill in the art in possession of the present disclosure will appreciate provides network access details for a resource device (e.g., the subnet and instance type information provided below):

node_types:
...
topology_temlpate:
...
network_subnet:
type: string
required: false
default: subnet/f5006535-c0c7-4fd7-8e17-80d18df371e7
instance_type:
type: string
required: false
default: instance_type/65c8de39-b530-4a1d-aba1-80a6241dbc49
...

The method 800 then proceeds to block 810 where the resource management system combines the resource/workload configuration information provided for the subset of resource devices to provide a resource/workload configuration file. In an embodiment, at block 810, the resource management engine 710a in the resource management system 706 may combine the resource-workload configuration information generated for each of the subset of the resource devices 704a-704c that were identified at block 806 in order to provide a resource/workload configuration file. Continuing with the example provided above, the resource management engine 710a may combine the TOSCA-based resource/workload configuration information provided for each of the subset of the resource devices 704a-704c that were identified at block 806 in order to provide a TOSCA-based resource/workload configuration file, and one of skill in the art in possession of the present disclosure will recognize how the TOSCA-based resource-workload configuration information may be combined to provide the TOSCA-based resource/workload configuration file using any of a variety of information combination techniques known in the art (e.g., “stitching” together a plurality of resource definitions provided by the TOSCA-based resource-workload configuration information in a manner that conforms to TOSCA and Yet Another Markup Language (YAML) standards).

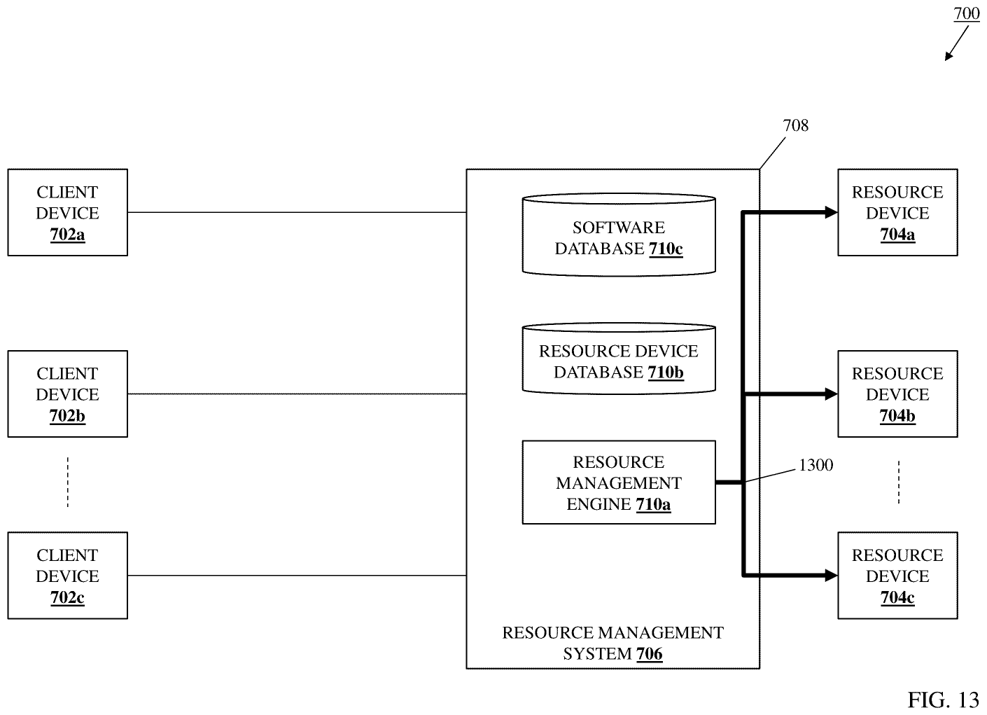

The method 800 then proceeds to block 812 where the resource management system uses the resource/workload configuration file to configure the subset of resource device to provide an LCS that performs the workload. With reference to FIG. 13, in an embodiment of block 812, the resource management engine 710a may perform resource device configuration operations 1300 that may include using the resource/workload configuration file (e.g., the TOSCA-based resource/workload configuration file in the example provided above) to configure the subset of resource devices 704a-704c identified at block 806 with the software identified at block 806 (i.e., using conventional TOSCA configuration file techniques described in the TOSCA standard). As will be appreciated by one of skill in the art in possession of the present disclosure, while all of the resource devices 704a-704c are illustrated as being configured at block 812, any combination of the resource devices 704a-704c may be configured (i.e., based on those resource devices having been identified as part of the subset at block 806) while remaining within the scope of the present disclosure as well.

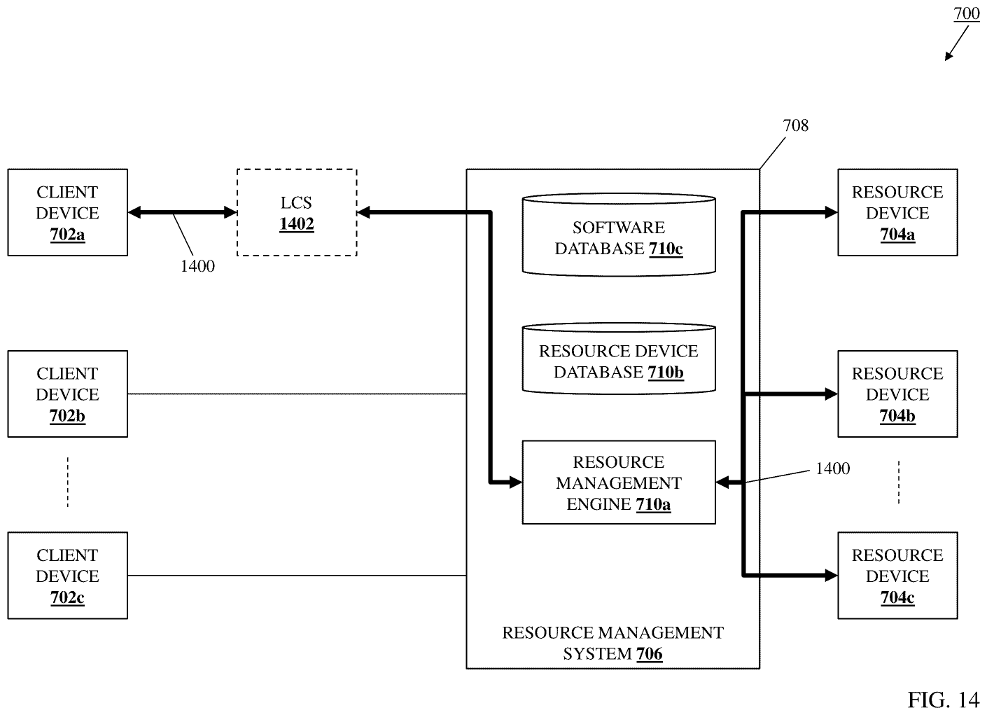

With reference to FIG. 14, following the configuration of the subset of resource devices 704a-704c identified at block 806 with the software identified at block 806, the resource management engine 710a may perform LCS provisioning operations 1400 that include using the subset of resource devices 704a-704c identified at block 806 with the software identified at block 806 to provide an LCS 1402 to the client device 702a that performs the workload requested by that client device at block 804. As will be appreciated by one of skill in the art in possession of the present disclosure, while all of the resource devices 704a-704c are illustrated as providing the LCS 1402 at block 812, any combination of the resource devices 704a-704c may provide the LCS 1402 (i.e., based on their having been identified as part of the subset at block 806) while remaining within the scope of the present disclosure as well.

The method 800 then returns to decision block 804. As such, the method 800 may loop such that the resource management engine 710a in the resource management system 706 continues to retrieve resource capability information and resource/workload configuration templates from resource devices as those resource devices become available, as well as identifies and configures subsets of resource devices to perform workloads when workload intents are received. Furthermore, for any LCS performing a workload for a client device (e.g., the LCS 1402 performing the workload for the client device 702a as described above), the resource devices used to provide that LCS may change, as the resource management engine 710a may be operate to identify additional, “new”, “replacement”, and/or other resource device(s) for providing that LCS, and may then fill the resource/workload configuration template(s) for those resource device(s) to generate a modified resource/workload configuration information, and combine that modified resource/workload configuration information (e.g., with any previously generated/“existing” resource/workload configuration information for resource devices that will continue to be used to provide that LCS) to provide a modified resource/workload configuration file, and use that modified resource/workload configuration file to configure the “existing” resource devices and the additional, “new”, “replacement”, and/or other resource device(s) to provide that LCS.

Thus, systems and methods have been described that provide a workload intent using “human-friendly” workload intent tag(s) (e.g., FQDN formatted tags), with those workload intent tags configured for use in identifying resource devices for providing an LCS that performs the workload, as well as for use in filling in resource/workload configuration templates (e.g., TOSCA-based resource/workload configuration templates) retrieved from those resource devices to generate a resource/workload configuration file that is used to configure those resource devices to provide the LCS that performs the workload.

For example, the workload provisioning system of the present disclosure may include a resource management system coupled to a client device and resource devices. The resource management system retrieves respective resource capability information and a respective resource/workload configuration template from each resource device. The resource management system then receives a workload intent from the client device with workload intent tag(s) defining respective workload capabilities desired for a workload, and uses it with the respective resource capability information to identify a subset of the resource devices to provide the respective workload capabilities. The resource management system then fills the respective resource/workload configuration template for each of the first subset of the resource devices based on their respective resource capability information to provide respective first resource/workload configuration information that it then combines to provide a first resource/workload configuration file that it uses to configure the first subset of resource devices to provide an LCS that performs the workload. As such, workloads may be provided without the need for users to perform time-consuming compilations and integrations of the information needed to enable the performance of those workloads that is required in conventional workload provisioning systems and requires a relatively high level of knowledge and training.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A workload provisioning system, comprising:
a plurality of resource devices;
a client device; and
a resource management system that is coupled to the client device and each of the plurality of resource devices, wherein the resource management system is configured to:
retrieve, from each of the plurality of resource devices, respective resource capability information and a respective resource/workload configuration template;
receive, from the client device, a workload intent that requests performance of a workload and that includes at least one workload intent tag that defines a respective workload capability desired for the workload;
identify, using the at least one workload intent tag and the respective resource capability information retrieved from each of the plurality of resource devices, a first subset of the plurality of resource devices that are configured to provide each of the respective workload capabilities defined by the at least one workload intent tag;
fill, based on the respective resource capability information retrieved from each of the first subset of the plurality of resource devices, the respective resource/workload configuration template retrieved from each of the first subset of the plurality of resource devices to provide respective first resource/workload configuration information;
combine the respective first resource/workload configuration information to provide a first resource/workload configuration file; and
configure, using the first resource/workload configuration file, the first subset of the plurality of resource devices to provide a Logically Composed System (LCS) that performs the workload.

2. The system of claim 1, wherein the respective resource capability information retrieved from each of the plurality of resource devices identifies functionality available from the operation of that resource device and functionality dependencies required for the operation of that resource device, and is configured for use by the resource management system to identify software that enables the functionality available from the operation of that resource device according to the functionality dependencies required for the operation of that resource device.

3. The system of claim 1, wherein the respective resource/workload configuration template retrieved from each of the plurality of resource devices is provided by a Topology and Orchestration Specification for Cloud Applications (TOSCA)-based resource/workload template.

4. The system of claim 1, wherein the filling the respective resource/workload configuration template retrieved from each of the first subset of the plurality of resource devices to provide respective first resource/workload configuration information based on the respective resource capability information retrieved from each of the first subset of the plurality of resource devices includes:
deriving, based on the respective first resource capability information retrieved from each of the first subset of the plurality of resource devices, at least one software dependency for the first subset of the plurality of resource devices; and
filling the respective resource/workload configuration template retrieved from each of the first subset of the plurality of resource devices to provide respective first resource/workload configuration information that addresses the at least one software dependency.

5. The system of claim 1, wherein the resource management system is configured to:
validate, prior to configuring the first subset of the plurality of resource devices to provide the LCS that performs the workload, the resource/workload configuration file.

6. The system of claim 1, wherein the at least one workload intent tag is provided in the workload intent in a Fully Qualified Domain Name (FQDN) format.

7. An Information Handling System (IHS), comprising:
a processing system; and
a memory system that is coupled to the processing system and that includes instructions that, when executed by the processing system, cause the processing system to provide a resource management engine that is configured to:
retrieve, from each of a plurality of resource devices that are coupled to the processing system, respective resource capability information and a respective resource/workload configuration template;
receive, from a client device that is coupled to the processing system, a workload intent that requests performance of a workload and that includes at least one workload intent tag that defines a respective workload capability desired for the workload;
identify, using the at least one workload intent tag and the respective resource capability information retrieved from each of the plurality of resource devices, a first subset of the plurality of resource devices that are configured to provide each of the respective workload capabilities defined by the at least one workload intent tag;
fill, based on the respective resource capability information retrieved from each of the first subset of the plurality of resource devices, the respective resource/workload configuration template retrieved from each of the first subset of the plurality of resource devices to provide respective first resource/workload configuration information;
combine the respective first resource/workload configuration information to provide a first resource/workload configuration file; and
configure, using the first resource/workload configuration file, the first subset of the plurality of resource devices to provide a Logically Composed System (LCS) that performs the workload.

8. The IHS of claim 7, wherein the respective resource capability information retrieved from each of the plurality of resource devices identifies functionality available from the operation of that resource device and functionality dependencies required for the operation of that resource device, and is configured for use by the resource management system to identify software that enables the functionality available from the operation of that resource device according to the functionality dependencies required for the operation of that resource device.

9. The IHS of claim 7, wherein the respective resource/workload configuration template retrieved from each of the plurality of resource devices is provided by a Topology and Orchestration Specification for Cloud Applications (TOSCA)-based resource/workload template.

10. The IHS of claim 7, wherein the filling the respective resource/workload configuration template retrieved from each of the first subset of the plurality of resource devices to provide respective first resource/workload configuration information based on the respective resource capability information retrieved from each of the first subset of the plurality of resource devices includes:
deriving, based on the respective first resource capability information retrieved from each of the first subset of the plurality of resource devices, at least one software dependency for the first subset of the plurality of resource devices; and
filling the respective resource/workload configuration template retrieved from each of the first subset of the plurality of resource devices to provide respective first resource/workload configuration information that addresses the at least one software dependency.

11. The IHS of claim 7, wherein the resource management engine is configured to:
validate, prior to configuring the first subset of the plurality of resource devices to provide the LCS that performs the workload, the resource/workload configuration file.

12. The IHS of claim 7, wherein the at least one workload intent tag is provided in the workload intent in a Fully Qualified Domain Name (FQDN) format.

13. The IHS of claim 7, wherein the resource management engine is configured to:
identify, using the at least one workload intent tag and the respective resource capability information retrieved from each of the plurality of resource devices, a second subset of the plurality of resource devices that are configured to provide each of the respective workload capabilities defined by the at least one workload intent tag;
modify, based on the respective resource capability information retrieved from each of the second subset of the plurality of resource devices, the respective resource/workload configuration template retrieved from each of the second subset of the plurality of resource devices to provide respective second resource/workload configuration information;
combine the respective second resource/workload configuration information to provide a second resource/workload configuration file; and
configure, using the second resource/workload configuration file, the second subset of the plurality of resource devices to provide the LCS that performs the workload.

14. A method for providing a workload, comprising:
retrieving, by a resource management system from each of a plurality of resource devices, respective resource capability information and a respective resource/workload configuration template;
receiving, by the resource management system from a client device, a workload intent that requests performance of a workload and that includes at least one workload intent tag that defines a respective workload capability desired for the workload;
identifying, by the resource management system using the at least one workload intent tag and the respective resource capability information retrieved from each of the plurality of resource devices, a first subset of the plurality of resource devices that are configured to provide each of the respective workload capabilities defined by the at least one workload intent tag;
filling, by the resource management system based on the respective resource capability information retrieved from each of the first subset of the plurality of resource devices, the respective resource/workload configuration template retrieved from each of the first subset of the plurality of resource devices to provide respective first resource/workload configuration information;
combining, by the resource management system, the respective first resource/workload configuration information to provide a first resource/workload configuration file; and
configuring, by the resource management system using the first resource/workload configuration file, the first subset of the plurality of resource devices to provide a Logically Composed System (LCS) that performs the workload.

15. The method of claim 14, wherein the respective resource capability information retrieved from each of the plurality of resource devices identifies functionality available from the operation of that resource device and functionality dependencies required for the operation of that resource device, and is configured for use by the resource management system to identify software that enables the functionality available from the operation of that resource device according to the functionality dependencies required for the operation of that resource device.

16. The method of claim 14, wherein the respective resource/workload configuration template retrieved from each of the plurality of resource devices is provided by a Topology and Orchestration Specification for Cloud Applications (TOSCA)-based resource/workload template.

17. The method of claim 14, wherein the filling the respective resource/workload configuration template retrieved from each of the first subset of the plurality of resource devices to provide respective first resource/workload configuration information based on the respective resource capability information retrieved from each of the first subset of the plurality of resource devices includes:
deriving, based on the respective first resource capability information retrieved from each of the first subset of the plurality of resource devices, at least one software dependency for the first subset of the plurality of resource devices; and
filling the respective resource/workload configuration template retrieved from each of the first subset of the plurality of resource devices to provide respective first resource/workload configuration information that addresses the at least one software dependency.

18. The method of claim 14, further comprising:
validating, by the resource management system prior to configuring the first subset of the plurality of resource devices to provide the LCS that performs the workload, the resource/workload configuration file.

19. The method of claim 14, wherein the at least one workload intent tag is provided in the workload intent in a Fully Qualified Domain Name (FQDN) format.

20. The method of claim 14, further comprising:
identifying, by the resource management system using the at least one workload intent tag and the respective resource capability information retrieved from each of the plurality of resource devices, a second subset of the plurality of resource devices that are configured to provide each of the respective workload capabilities defined by the at least one workload intent tag;
modifying, by the resource management system based on the respective resource capability information retrieved from each of the second subset of the plurality of resource devices, the respective resource/workload configuration template retrieved from each of the second subset of the plurality of resource devices to provide respective second resource/workload configuration information;
combining, by the resource management system, the respective second resource/workload configuration information to provide a second resource/workload configuration file; and
configuring, by the resource management system using the second resource/workload configuration file, the second subset of the plurality of resource devices to provide the LCS that performs the workload.
